(19) United States
(12) Patent Application Publication
(10) Pub. No.: US 2009/0308614 A1
(43) Pub. Date: Dec. 17, 2009

(54) Coated extrudable ball seats

(76) Inventors: James S. Sanchez, Tomball, TX (US); George E. Givens, Spring, TX (US); Ping Duan, Spring, TX (US)

Correspondence Address: GREENBERG TRAURIG (HOU);INTELLECTUAL PROPERTY DEPARTMENT, 1000 Louisiana Street, Suite 1800, Houston, TX, 77002, US

(21) Appl. No.: 12/157,510

(22) Filed: Jun. 11, 2008

(51) Int. Cl. F16K 1/42; E21B 34/06; F16K 5/06

(52) U.S. Cl. 166/328; 251/172; 251/359

(57) ABSTRACT

Ball seats comprising at least one sealing material facilitate restricting fluid flow through the ball seat when a plug, such as a ball, is landed on the seat. The plug is forced into the sealing material causing the sealing material to be deformed and to at least partially deform to a shape reciprocal to the shape of the plug, thereby reducing leakage around the plug and through the seat. In one particular embodiment, the ball seat is an extrudable ball seat. Suitable sealing materials include polymers and elastomers.

### BACKGROUND

1. Field of Invention

The present invention is directed to ball seats for use in oil and gas wells and, in particular, to extrudable ball seats having a coating to facilitate sealing the ball to the seat.

2. Description of Art

Ball seats are known in the art. Broadly, ball seats are devices placed within a conduit string or a wellbore through which a fluid is permitted to flow. In some instances it is desired to restrict or prevent flow through the conduit or wellbore so that pressure can build-up within the conduit or wellbore to actuate a downhole tool such as a setting tool to set an anchor or a packer within the conduit or wellbore. Ball seats are used to restrict or prevent such fluid flow by landing or seating a plug or ball on the seat to block flow. Typically, the seat and the ball are formed out of metallic materials such that a rounded portion of the ball lands on a flat surface of the seat. In other embodiments, the seat may have a shape that is reciprocal to the ball, e.g., arcuate to be reciprocally-shaped to the ball.

One particular type of ball seat is known as an “extrudable ball seat” because the seat deforms or “extrudes” due to pressure forcing the ball into the seat until the ball is ultimately allowed to pass through the seat after increased pressure above the ball is not longer needed.

Although the term ball is used herein to refer to the seats disclosed herein, it is to be understood that the seats may be used in connection with another type of plug or plug member, such as a plug dart. Therefore, except where expressly identified as requiring the plug member or plug to be a ball, it is to be understood that “ball” and “plug” are used herein interchangeably.

### SUMMARY OF INVENTION

Broadly, ball seats for receiving a plug element for use in downhole operations in a wellbore comprise a tubular having an inner wall surface defining a bore. The bore is divided into an upper portion and a lower portion, the upper portion having an upper diameter and the lower portion having a smaller lower diameter. A seat is disposed along the inner wall surface between the upper portion and the lower portion so that the seat transitions the inner wall surface from the upper portion to the lower portion. A sealing element is disposed on the seat for receiving a plug element, such as a ball. The sealing element comprises a sealing material that is deformable to a shape reciprocal to a plug shape of a plug element disposed on the seat. The sealing material may comprise a polymer or an elastomer. Additionally, the sealing element may be disposed along the inner wall surface above the seat to facilitate receiving the plug element and sealing the flow path through the ball seat.

In one specific operation of the ball seat, the ball seat restricts fluid flow through a conduit disposed within a wellbore when disposed within the conduit. After the plug element is landed on the seat and, therefore, the sealing element, pressure builds above the plug and forces the plug into the sealing element. In so doing, the sealing element is at least partially deformed to a shape substantially reciprocal to a plug shape of the plug to restrict flow through the conduit.

### BRIEF DESCRIPTION OF DRAWINGS

FIG. 1 is a cross-sectional side view of one specific embodiment of a ball seat shown in a run-in position in which the ball is engaged with the seat to restrict flow through the seat.

FIG. 2 is a partial cross-sectional view of the seat of the ball seat shown in FIG. 1.

FIG. 3 is a cross-sectional side view of the embodiment shown in FIG. 1, in which the ball has been extruded or forced through the seat so that fluid flow is established through the seat.

While the invention will be described in connection with the preferred embodiments, it will be understood that it is not intended to limit the invention to that embodiment. On the contrary, it is intended to cover all alternatives, modifications, and equivalents, as may be included within the spirit and scope of the invention as defined by the appended claims.

### DETAILED DESCRIPTION OF INVENTION

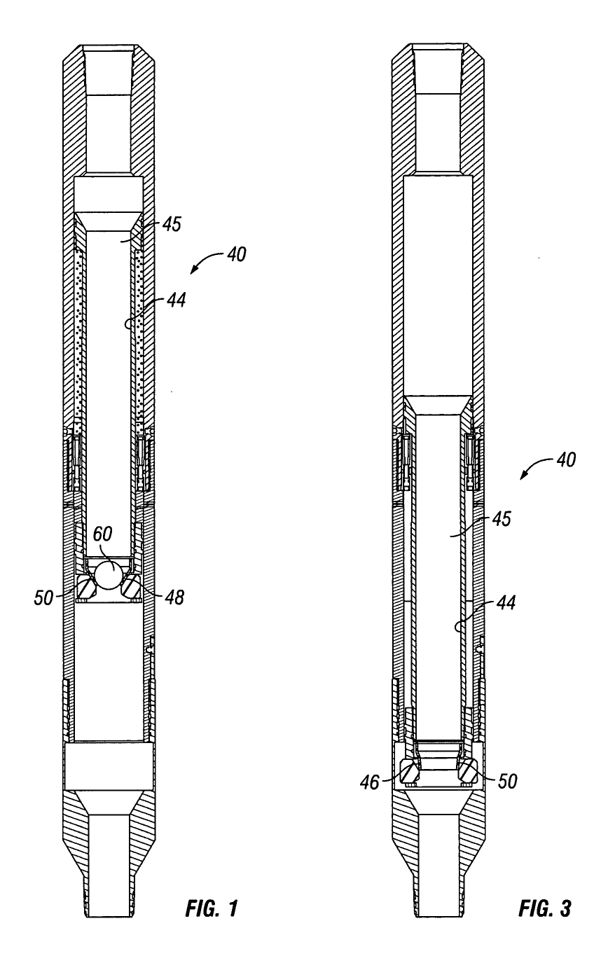

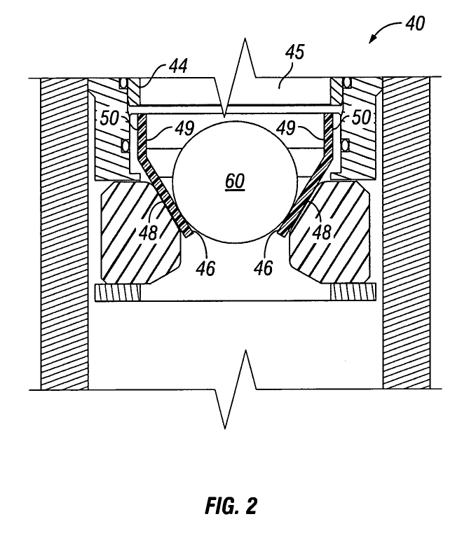

Referring to FIGS. 1-3, in one specific embodiment, ball seat 40 comprises tubular member 42 having inner wall surface 44 defining bore 45. Bore 45 is restricted by seat 48. As shown best in FIG. 2, seat 48 has landing surface 46 and, disposed thereon, sealing element 50 comprising a sealing material. In one embodiment, sealing element 50 is comprised completely of one or more sealing material. In another embodiment, only a portion of sealing element 50 comprises a sealing material. In still other embodiments, sealing element 50 comprises two or more different sealing materials to customize and optimize the sealing ability of sealing element 50 to the plug (shown as ball 60 in FIGS. 1-2).

The term “sealing material” as used herein for sealing element 50 means that the material is capable of being deformed, e.g., being forced or extruded around or along the outer wall surface of the plug (for example, ball 60 shown in FIGS. 1-2) when the plug is landed or seated onto landing surface 46 of seat 48 (FIGS. 1-2). The sealing material may be any material known to persons of ordinary skill in the art that can be moved, e.g., compressed, deformed, or extruded, over an amount of time by a force acting against the plug and forcing the plug into sealing element 50. Suitable sealing materials include polymers and elastomers, for example, the Adiprene polyurethane prepolymers available from Chemtura in Middlebury, Conn. Most commercially available Adiprene polyurethane prepolymers are liquid at room temperature and are able to easily mix with liquid curatives either di-ols such as 1,4-Butanediol (BDO) or di-amine such as dimethylthiotoluenediamine (DMTDA). The mixture is then poured into a mold which consists of sealing element 50 followed by post-curing at elevated temperature such as 100° C. for about 8 hours.

In one particular embodiment, sealing element 50 is formed from the sealing materials using Adiprene LF963A from Chemtura and cured with Dimethylthiotoluenediamine (DMTDA) commercially available under trade name as Ethacure 300 from Albemarle in Baton Rouge, La. In another embodiment, sealing element 50 is formed from the sealing materials using Adiprene LFP3940A from Chemtura and cured with 1,4-Butanediol (BDO) commercially available under trade name as Vibracure A250 from Chemtura.

In one particular embodiment sealing element 50 is formed completely out of one, sealing material and sealing element 50 comprises a torroidal-shaped single member. In other embodiments, sealing element 50 is disposed along inner wall surface 44 above landing surface 46, such as along portion 49 (shown best in FIG. 2) to provide greater ability of sealing element 50 to deform to a shape substantially reciprocal to the shape of the plug.

It is to be understood that the apparatuses and methods disclosed herein are considered successful if the sealing material is sufficiently moved such that the surface area of the plug, e.g., ball 60 in FIGS. 1-2, that is in contact with sealing element 50 is greater than if the plug were resting on a surface of the ball seat. As persons skilled in the art will recognize, a small indention in sealing element 50 by the plug can increase the contact point between the plug and landing surface 46 such that sufficient sealing of sealing element 50 has occurred.

In operation of one specific embodiment, ball seat 40 is disposed within wellbore or a conduit, e.g., work, string that is placed into the wellbore. Connection of ball seat 40 to the conduit can be accomplished through any method or device known in the art, such as threads disposed at the upper and lower ends of ball seat 40. A plug, such as ball 60 is disposed on landing surface 46 to restrict fluid flow through ball seat 40. Fluid pressure acting downward increases downward force onto ball 60 which drives ball 60 into sealing element 50 disposed on seat 48. The fluid pressure above seat 48 is increased to actuate a downhole tool or perform some other downhole operation. As the downward force increases, sealing element 50 is deformed toward a shape reciprocal to the shape of the plug, i.e., conforms to the shape of ball 60, thereby increasing the seal between ball 60 and seat 48 and, thus, decreasing the likelihood of fluid leaks being formed between ball 60 and seat 48. After the downhole operation is completed, and increased pressure above seat 48 is no longer needed or required, the fluid pressure is continued to be increased until seat 48 is moved axially downward so that seat 48 can radially expand allowing ball 60 to pass through seat 48 resulting in the view shown in FIG. 3.

In one specific embodiment of manufacturing the ball seats having the sealing elements discussed herein, the seat is formed within a tubular member made of steel. The ball seat is then lightly sandblasted and placed in a mold. A sealing material is heated and then poured into the mold and onto the seat of ball seat. A vacuum is then placed on the mold to remove bubbles or excess air within the sealing material. The mold is then placed in an oven and heated to cure the sealing material, thereby forming the sealing element on the seat of the ball seat. After the mold is removed from the oven, it is allowed to cool and the mold is removed leaving the sealing element disposed on the seat. In one particular embodiment, the sealing element has a thickness of approximately 0.030 inches, although the thickness can easily be increased or decreased depending on the overall size of the ball seat and the size and shape of the plug or ball. The sealing element is then trimmed of any excess material and the ball seat is ready to be placed into a conduit or wellbore for use.

Although the apparatus described in greater detail with respect to FIGS. 1-2 is ball seat 40 having ball 60, it is to be understood that the apparatuses disclosed herein may be any type of seat known to persons of ordinary skill in the art. For example, the apparatus may be a drop plug seat, wherein the drop plug temporarily blocks the flow of fluid through the wellbore. Therefore, the terms “plug” and “plug element” as used herein encompass ball 60 as well as any other type of device that is used to temporary block the flow of fluid through the wellbore.

In other embodiments, in addition to the seat comprising a sealing material, the plug also comprises a sealing material disposed along an outer wall surface of the plug. In still other embodiments, the plug, and not the seat, comprises the sealing material.

It is to be understood that the invention is not limited to the exact details of construction, operation, exact materials, or embodiments shown and described, as modifications and equivalents will be apparent to one skilled in the art. For example, the seat may be used in connection with a ball, dart, or any other type of plug or plug member that is used to restrict or prevent fluid flow through the seat. Additionally, the sealing element may be formed partially or completely out of one or more sealing materials. Further, the ball seat is not required to be an “extrudable” ball seat, i.e., one in which the seat is deformed such as the embodiment of FIGS. 1-3. Instead, the ball seat may be “static” and the ball is either milled out or itself deformed to remove it from the ball seat after increased pressure above the ball seat is no longer required. Further, the ball seat may be disposed on a collet or other axially or radially movable component such that as the ball is forced into the seat, the collet or other component moves axially or radially until the collet or component radially expands or otherwise moves in such a way to allow the ball to be flowed through the seat. Moreover, the ball seat may include a plug already engaged with the seat during run-in or the plug may be absent and later landed on the seat. Accordingly, the invention is therefore to be limited only by the scope of the appended claims.

What is claimed is:

1. A ball seat for receiving a plug element for use in downhole operations in a wellbore, the ball seat comprising:
a tubular having an inner wall surface defining a bore, the bore being divided into an upper portion and a lower portion, the upper portion having an upper diameter and the lower portion having a lower diameter, the upper diameter being greater than the lower diameter;
a seat disposed along the inner wall surface, the seat transitioning the inner wall surface from the upper portion to the lower portion; and
a sealing element disposed on the seat, the sealing element comprising a sealing material that is deformable to a shape reciprocal to a plug shape of a plug element disposed on the seat.

2. The ball seat of claim 1, wherein the sealing material comprises a polymer.

3. The ball seat of claim 1, wherein the sealing material comprises an elastomer.

4. The ball seat of claim 1, wherein the inner wall surface of the bore along the seat comprises a variable diameter.

5. The ball seat of claim 1, wherein the sealing element is disposed along a portion of the inner wall surface above the seat.

6. The ball seat of claim 1, wherein the seat is extrudable.

7. The ball seat of claim 1, further comprising a plug element landed on the seat.

8. An improved ball seat, the improvement comprising
a sealing element disposed on a seat of the ball seat, the sealing element comprising at least one sealing material.

9. The improvement of claim 8, wherein the sealing material comprises a polymer.

10. The improvement of claim 8, wherein the sealing material comprises an elastomer.

11. The improvement of claim 8, wherein the sealing element is further disposed along a portion of an inner wall surface of the ball seat located above the seat.

12. The ball seat of claim 8, wherein the seat is extrudable.

13. A method of restricting fluid flow through a conduit disposed within a wellbore, the method comprising the steps of:
(a) disposing a ball seat within a conduit, the ball seat comprising an opening and a sealing element, the sealing element comprising a sealing material;
(b) running the conduit into a wellbore to a desired location;
(c) disposing a plug on the sealing element to block the opening;
(d) forcing the plug into the sealing element causing the sealing element to at least partially deform to a shape substantially reciprocal to a plug shape of the plug to restrict flow through the opening in the seat.

14. The method of claim 13, wherein during step (d), fluid is prevented from flowing around the plug and through the opening of the seat.

15. The method of claim 13, further comprising the step of increasing the pressure forcing the plug into the seat until the plug is forced through the opening in the seat to establish fluid flow through the opening of the seat.

16. The method of claim 15, wherein the plug is forced through the seat by radially expanding the opening through the seat.

17. The method of claim 13, wherein step (c) is performed after step (b).
